(19) United States
(12) Patent Application Publication
(10) Pub. No.: US 2013/0171611 A1
(43) Pub. Date: Jul. 4, 2013

(54) APPARATUS FOR SIMULATING OPERATION OF FAN BLADES IN A GAS TURBINE

(71) Applicants: Andrew Thomas Hynous, Greenville, SC (US); Brian Ralph Thompson, Valrico, FL (US)

(72) Inventors: Andrew Thomas Hynous, Greenville, SC (US); Brian Ralph Thompson, Valrico, FL (US)

(73) Assignee: General Electric Company, Schenectady, NY (US)

(21) Appl. No.: 13/342,655

(22) Filed: Jan. 3, 2012

(51) Int. Cl. G09B 25/00

(52) U.S. Cl. 434/389

(57) ABSTRACT

This disclosure describes a training apparatus, wherein embodiments of the training apparatus simulate operation of fan blades in a turbine engine. An advantage that practice of some disclosed embodiments of the training apparatus is to provide a platform to train skills for maintaining and servicing turbine engines without placing the individual and/or customer hardware in jeopardy.

### BACKGROUND OF THE INVENTION

The subject matter disclosed herein relates to turbine engines and, in particular, to an apparatus that simulates movement of fan blades found in turbine engines, wherein the apparatus provides a platform to train individuals to measure parameters of the fan blades.

A gas turbine engine includes a compressor, a combustor, and a turbine. The compressor and turbine generally include rows of fan blades that extend longitudinally along a center axis of the engine. Groups of the fan blades form and delineate various “stages” within the turbine engine. The stages include a row of stator blades and a row of rotor blades, which rotate about the central axis on a shaft relative to the stator blades. In operation, the compressor compresses a flow of air. The combustor uses the compressed air to combust a supply of fuel. Combustion results in hot expanding gases (also, “working fluid”) that expand through the turbine of the engine. The flow of working fluid through the turbine causes the rotor blades to rotate, rotating the shaft and generating electrical power.

Construction of the turbine engine and, in particular, clearance (also “tip clearance”) between the rotor blades and the outer casing of the turbine engine impact the efficiency of gas turbine engines. Smaller tip clearance improves efficiency by decreasing the leakage flow around the rotor blades. However, the smaller tip clearances also increase the risk that the rotating rotor fan blades will contact or rub against the outer casing during operation of the engine. Moreover, another factor that further increases these risks is that the tip clearance can change during operation due, for example, to thermal expansion of the engine components. Of course, contact between parts during operation is highly undesirable because it can cause extensive damage to the engine, failure of certain components, and, in some instances, may increase the tip clearances because of wear and mechanical abrasion of the components that rub together.

To verify operation and monitor tip clearance, technicians periodically perform maintenance protocols on the turbine engine. Part of the maintenance protocol is to measure tip clearance using designated measurement kits and access areas on the turbine engine. If interference with the fan blades and the inner casing are found, another part of the maintenance protocol is to modify, e.g., by grinding the tip of the offending fan blades to fix the problem. Further measurements are then made to verify the amount of material that grinding process removes.

The discussion above merely provides general background information and is not intended as an aid in determining the scope of the claimed subject matter.

### BRIEF DESCRIPTION OF THE INVENTION

This disclosure describes a training apparatus, wherein embodiments of the training apparatus simulate operation of rotating fan blades, e.g., as found in a turbine engine, compressor, or other asset. An advantage that practice of some disclosed embodiments of the training apparatus is to provide a platform to train and develop skills for maintaining and servicing turbine engines without placing the individual and/or customer hardware in jeopardy.

As set forth below, the disclosure provides, in one embodiment, a training device that replicates operation of fan blades in a turbine engine. The training device comprises a motor and a shaft coupled to the motor. The shaft has a central axis and an array of blade elements disposed radially about the central axis. The training device also comprises a housing enclosing the array, the housing comprising a plurality of probe mounting members with openings extending through the housing and exposing a top surface of the blade elements in the array. The plurality of probe mounting members comprises a first probe member with a bore surface radially outward of and tangential to the center axis of the shaft, the openings comprising a bore extending normal to the bore surface to receive a first probe inserted therein. The plurality of probe mounting member also comprises a second probe member with an adapter surface extending away from the housing to support an adapter that positions a second probe normal to the top surface of the blades, the openings comprising an adapter opening proximate the adapter surface, the adapter opening exposing the top surface of the blade elements to the second probe.

The disclosure also provides, in another embodiment, an apparatus for simulating travel of fan blades of a turbine engine. The apparatus comprises a shaft having a central axis and an array of blade elements disposed radially about the central axis. The apparatus also comprises a housing enclosing the array of blade elements, the housing comprising integrated members to position probes proximate a top surface of the blade elements. In one example, rotation of the shaft, in combination with the number of the blade elements, simulates one or more stages of the turbine engine.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a perspective view of an exemplary training device that simulates operation of fan blades in a turbine engine;

FIG. 2 depicts a cross-section of the training device of FIG. 1; and

FIG. 3 depicts a schematic wiring diagram of an exemplary training device that simulates operation of fan blades in a turbine engine.

### DETAILED DESCRIPTION OF THE INVENTION

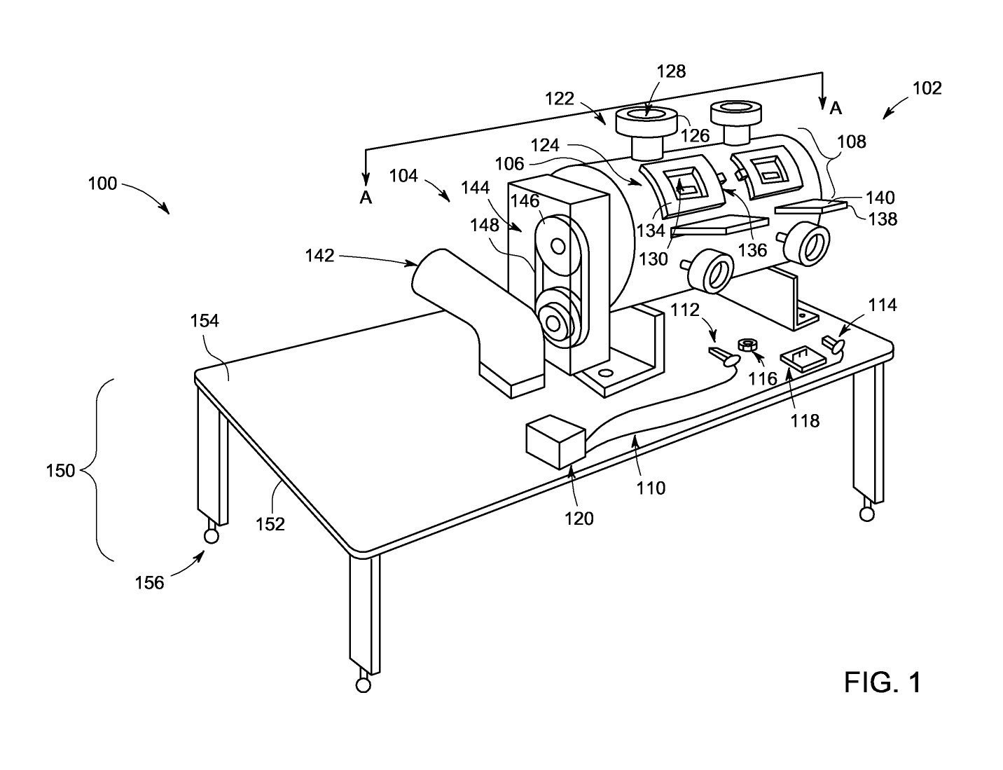

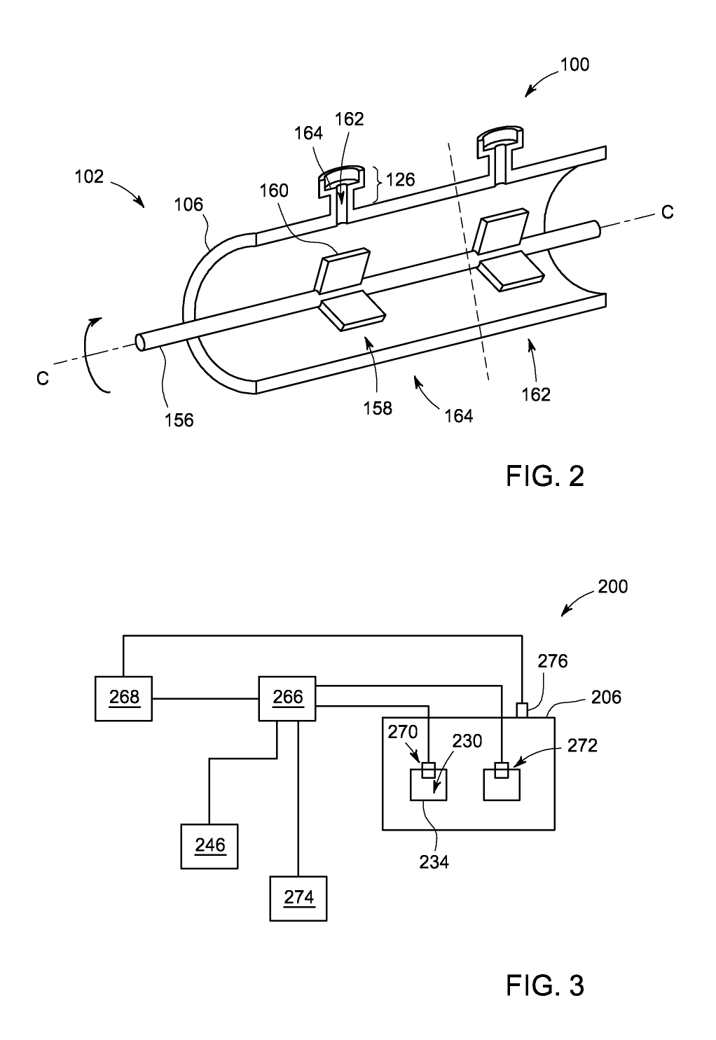

FIGS. 1 and 2 depict an exemplary training device 100 to train individuals to perform measurements on components of a turbine engine. Embodiments of the training device 100 provide a platform on which an end user (e.g., a technician) can practice certain measurement techniques to learn new skills and/or sharpen existing abilities. The platform can simulate the look-and-feel of locations on the actual turbine engine where measurements are taken, thus providing the proper environment to train individuals without the need to engage actual customer hardware. This feature reduces risks both to the actual hardware and to the novice end user who may not have the necessary experience and/or skill level to execute the measurement techniques with sufficient precision to avoid damage to the hardware or injury to themselves.

FIG. 1 shows a perspective view of the training device 100. In FIG. 1, the training device 100 includes a test assembly 102 and a drive assembly 104 that imparts motion (e.g., rotation) to components of the test assembly 102. In one example, the combination of these elements simulates rotation of fan blades that are found in the various stages of the turbine engine. The test assembly 102 has a housing 106 with one or more probe mounting members 108 to position and secure components of a measurement kit, generally identified by the numeral 110. The measurement kit 110 can include one or more probes (e.g., a clearance probe 112 and a grinding probe 114), one or more spacers 116, and an adapter plate 118. Examples of the probes include optical proximity sensors, although this disclosure contemplates that the probe mounting members 108 can accommodate other types of probes as desired. In one embodiment, the measurement kit 110 also includes a data collection device 120 that couples with the probes to collect data (including values for tip clearance) representative of operation and features of the test assembly 102.

The probe mounting members 108 include a clearance measurement member 122 and a grinding measurement member 124. Generally the clearance measurement member 122 includes a boss feature 126 with a first bore 128. Additional details of the clearance measurement member 122 are found in FIG. 2 and discussed below. The grinding measurement member 124 includes an adapter opening 130 that exposes the interior of the housing 106. A cover assembly prevents access through the opening 130. The cover assembly can include a cover 134 and a closure 136 (e.g., a knob, lock, hasp, latch). Below and proximate the adapter opening 130, the grinding measurement member 124 has a plate 138 with an adapter surface 140.

In practice, a technician-in-training (“the technician”) implements the measurement kit 110 on the test assembly 102 to improve skills necessary to collect data from actual turbine engines. For example, the technician can position the clearance probe 112 in combination with the spacer 116 in the first bore 128 of the clearance measurement member 120. The technician can also displace the cover 134 and position the adapter 118 on the adapter surface 140 of the grinding measurement member 124. The adapter 118 can receive the grinding probe 114, a feature of the measurement kit 110 that permits use of the same type of probe for the clearance probe 112 and the grinding probe 114. Data capture can occur when the technician couples the clearance probe 112 and the grinding probe 114 to the data collection device 120 and activates the drive assembly 104.

In one embodiment, the drive assembly 104 comprises a motor 142 (e.g., electric, pneumatic, hydraulic) and a belt drive 144 with one or more pulleys 146 and a belt 148. Other examples of the drive assembly 104 may substitute the belt drive 144 with various arrangements of gears and gear trains to achieve the desired performance characteristics for the training device 100. The belt drive 144 couples with the test assembly 102 to transfer motion from the motor 140 to moving parts in the housing 106. The training device 100 can also include a base structure 150 to support the test assembly 102 and/or the drive assembly 104. Much like a table or similar supporting configuration of elements, the base structure 150 can comprise a frame 152 with a planar top 154 as well as various features that afford mobility to the training device 100. These features may include rolling devices 156 (e.g., wheels and/or castors). In other examples, the features may also include one or more structural members, e.g., that affix to the frame 152. These structural members provide engagement points for fork-lift trucks and/or crane mechanisms to transport the entire training device 100 to remote locations.

Configurations of the drive assembly 104 work in combination with the moving parts of the test assembly 102 to cause the moving parts to appear to operate in the same manner as the fan blades in the actual turbine engine. For example, the moving parts simulate the same travel speeds of the fan blades. This feature ensures data collection on the training device 100 is substantially the same as data collection on the actual turbine engine, thus permitting implementation of the measurement kit 110 and its protocols in the same manner as would normally occur on the actual turbine engine. The continuity of operation of the training device 100 and the actual turbine engine affords training (and recertification) of skills representative of the skills the technician needs to accomplish the measurement tasks in the field.

Examples of the moving parts and other features of the training device 100 are best shown in FIG. 2, which depicts a cross-section of the training device 100 taken along A-A of FIG. 1. In FIG. 2, the test assembly 102 includes a shaft 156 with a central axis C. A plurality of blade elements 158 couple with the shaft 156 radially about the central axis C. The blade elements 158 have a top surface 160 that interacts with the clearance probe 112 and the grinding probe 114 to register data about the blade elements 158. In one embodiment, the boss feature 126 includes a second bore 162, which extends from a bore surface 164 through the material of the housing 106. During implementation of the training device 100, the technician inserts a portion of the clearance probe 112 into the second bore 162. The bore surface 164 is, in one example, radially offset from the central axis C to provide a tangential surface for proper alignment of the probe with the top surface 160 of the blade elements 158.

The shaft 156 may extend the length of the housing 106 with a portion protruding out of one end for engagement, e.g., with the belt drive 144 (FIG. 1). The housing 106 may include other structural features (not shown), e.g., one or more bearings and/or bearing surfaces that support the shaft 156 and permit its rotation in the housing 106. In one embodiment, the blade elements 158 can form one or more mock stages (e.g., a first mock stage 162 and a second mock stage 164), which correspond to and simulate the stages found in the actual turbine engine. The mock stages can have different numbers of blade elements 156. The number may depend on the number of fan blades found in the corresponding stage of the actual turbine engine. In one configuration of the training device 100, the first mock stage 162 has 5 of the blade elements 158 and the second mock stage 164 has 6 of the blade elements 158. The blade elements 158 are of generally the same size and shape, e.g., with a top surface that is from about 5 mm to about 10 mm. For this configuration of the fan blade elements 158, the drive assembly 104 rotates the shaft 154 at, in one example, about 70 RPM. This configuration of factors (e.g., the number of blades and speed of rotation) simulate operation of a stage in an actual turbine engine with forty-six fan blades and with seventy fan blades. However, in other examples, these factors including the speed of rotation, the number of blade elements 156, and/or the dimensions of the top surface 160 can be selected to effectively simulate the dynamics of stages in the actual turbine engine that have more or less fan blades.

In addition to being amenable to the various configurations of stages in the turbine engines, the training device 100 can accommodate any number of stages. For example, the housing 106 and shaft 156 can be elongated to fit more of the mock stages. This housing 106 can also accommodate additional locations of the probe mounting members 108. In other examples, the shaft 156 and the blade elements 158 may be adjustable, changeable, or otherwise configured to permit modifications that allow the mock stage to simulate a variety of stages in the turbine engine.

The housing 106 may include markings (not shown) that distinguish between the first mock stage 162 and the second mock stage 164 to indicate the features of the stage. During implementation of the training device 100, e.g., for training, the technician can find these markings to identify the mock stage and to select the appropriate measurement protocol that corresponds to the protocol for the corresponding stage of the actual turbine engine. This verification may direct the technician to perform appropriate steps and/or protocols necessary to accurately collect data and to properly calibrate the equipment of the measurement kit 110 if necessary. The measurement protocol may determine, for example, the arrangement of the probes (including use of spacer and/or adapters) and the mode of operation for the data collection device.

Construction of the test assembly 104 (e.g., the housing 106, the shaft 156, and the blade elements 158) can use various metals (e.g., steel, stainless steel, aluminum, etc.) and other materials of similar mechanical properties (e.g., tensile strength). These materials can be machined using known techniques (e.g., machining, grinding, turning, etc.). For construction of multiple training devices, other techniques, e.g., molding and casting, may be less expensive and provide parts for easier assembly.

FIG. 3 illustrates a schematic wiring diagram for an exemplary training device 200 to illustrate certain safety features that prevent injury to the technician and/or damage to the device. In FIG. 3, the training device 200 includes a housing 206 with an opening 230 and a cover 234 secured thereto. A motor 246 couples with the housing 206. The motor 246 couples with a switch 266 that regulates power, generally identified with the numeral 268, to energize the motor 246.

In one embodiment, the training device 200 also includes safety mechanisms (e.g., a first safety mechanism 270 and a second safety mechanism 272) that couple with the cover 230. The safety mechanisms and an override device 274 couple to the switch 266. There are two safety mechanisms to accommodate the corresponding mock stages and configuration of the probe measuring members of the examples disclosed herein. Operation of the safety mechanisms prevents rotation of the blade elements when one of the covers is open unless the override device 274 is actuated. Examples of the override device 274 include push buttons and toggle switches, although artisans having skill in the relevant electrical and electro-mechanical arts could identify a variety of devices suitable for this purpose. In one embodiment, the training device 200 can include a status indicator 276, which can include a light or other visible and/or audible indicator of the status of the training device 200. For example, the status indicator 276 may include a light that illuminates when the drive system activates to rotate the shaft.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate in the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A training device that replicates operation of a fan blades in a turbine engine, said training device comprising:
a motor;
a shaft coupled to the motor, the shaft having a central axis and an array of blade elements disposed radially about the central axis; and
a housing enclosing the array, the housing comprising a plurality of probe mounting members with openings extending through the housing and exposing a top surface of the blade elements in the array, the plurality of probe mounting members comprising,
a first probe member with a bore surface radially outward of and tangential to the center axis of the shaft, the openings comprising a bore extending normal to the bore surface to receive a first probe inserted therein, and
a second probe member with an adapter surface extending away from the housing to support an adapter that positions a second probe normal to the top surface of the blades, the openings comprising an adapter opening proximate the adapter surface, the adapter opening exposing the top surface of the blade elements to the second probe.

2. The training device of claim 1, further comprising a belt drive coupling the motor to the shaft.

3. The training device of claim 1, further comprising a cover disposed in position on the housing to prevent access to the blade elements via the second opening.

4. The training device of claim 3, further comprising a safety mechanism that prevents rotation of the shaft when the cover is displaced.

5. The training device of claim 1, wherein the array comprises five or more blade elements.

6. The training device of claim 1, wherein rotation of the shaft, in combination with the number of the blade elements, simulates one or more stages of the turbine engine.

7. The training device of claim 1, further comprising a stand supporting the housing.

8. The training device of claim 1, wherein the bore surface is spaced apart from the outer surface of the housing.

9. The training device of claim 1, wherein the bore surface positions the probe at an offset distance from the top surface of the blades, and wherein the offset distance permits the first probe to collect data representative of tip clearance of fan blade in the turbine engine.

10. The training device of claim 1, further comprising a plate secured to the housing, the plate extending away from the housing forming the adapter surface for the adapter.

11. An apparatus for simulating travel of fan blades of a turbine engine, said apparatus comprising:
a shaft having a central axis and an array of blade elements disposed radially about the central axis;
a housing enclosing the array of blade elements, the housing comprising integrated members to position probes proximate a top surface of the blade elements,
wherein rotation of the shaft, in combination with the number of the blade elements, simulates one or more stages of the turbine engine.

12. The apparatus of claim 11, wherein the integrated members comprise a bore feature with a bore surface radially outer of and tangential to the central axis, wherein the bore surface positions a first probe to collect data representative of tip clearance of fan blade in the turbine engine.

13. The apparatus of claim 11, wherein the integrated members comprise an adapter opening and an adapter plate secured to the housing to position an adapter surface proximate the adapter opening, and wherein the adapter surface positions an adapter with a probe to collect data representative of material removal from the fan blades in the turbine engine.

14. The apparatus of claim 11, further comprising a safety mechanism that prevents rotation of the shaft, the safety mechanism responsive to displacement of a cover provided as one of the integrated members.

15. The apparatus of claim 11, further comprising a drive assembly comprising a motor and a belt drive that transfers motion from the motor to the shaft.
